(19) United States
(12) Patent Application Publication
(10) Pub. No.: US 2007/0152026 A1
(43) Pub. Date: Jul. 5, 2007

(54) Transient liquid phase bonding method

(76) Inventors: Daewoong Suh, Phoenix, AZ (US); Leonel R. Arana, Phoenix, AZ (US); John Heck, Berkeley, CA (US)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 11/323,548

(22) Filed: Dec. 30, 2005

(51) Int. Cl. B23K 20/00; B23K 28/00; B23K 35/14

(52) U.S. Cl. 228/193; 228/56.3

(57) ABSTRACT

A bonding method, comprising locating a composition between and in contact with first and second pieces, the composition including a bonding metal which is one of Zn, Sn, In, and Bi, and a melting temperature depressing metal which is different than the bonding metal and is one of Zn, Sn, In, and Bi, heating the composition to diffuse the melting temperature depressing metal into the first piece and increase the melting temperature of the composition, and allowing the composition to cool.

### BACKGROUND OF THE INVENTION

1). Field of the Invention

Embodiments of this invention relates to a bonding process that utilizes lower bonding temperatures than conventional processes.

2). Discussion of Related Art

Current industry standard solders, such as eutectic Sn—Pb, and most lead-free solders (e.g., Sn—Ag—Cu) under development melt at temperatures of 183° C. and above. This high melting temperature (and therefore high reflow temperature) unavoidably imposes great thermal stress due to a thermal expansion mismatch among components, often resulting in device failure. More importantly, this high reflow temperature is not acceptable for heat-sensitive devices such as polymer memory and optoelectronic devices, which are becoming more and more common. The average device working temperature is around 80° C. The small thermal window between 80° C. and 183° C. poses tremendous challenges for finding suitable solder materials, because there are very limited numbers of low melting temperature (Tm) solders available within this thermal window. For example, Sn—In (Tm=118° C.) is too soft and has very high creep deformation, posing serious reliability concerns in baking and thermomechanical fatigue. Bi-containing low-Tm solders are highly strain-rate sensitive. Most of In—Bi low-temperature solders have a room temperature microstructure that mostly consists of intermetallic compounds between In and Bi, resulting in highly brittle alloys. Low-Tm solders whose Tm is around 100° C. have a homologous temperature approaching >0.75 to 0.8 under normal working conditions, which poses tremendous reliability concerns because of extensive high-temperature deformation. Ultralow Tm solders (Tm<100° C.) cannot be used, because their Tm is close to the normal working temperature of components. Many low Tm solders also have toxic materials, such as Cd.

There is a growing trend in the microelectromechanical system (MEMS) industry toward wafer-level hermetic packaging. One promising technique for wafer-level hermetic packaging involves intermediate-layer wafer bonding. In this procedure, a lid wafer is bonded to the MEMS wafer using a solder or glass intermediate layer, and the wafer stack is subsequently diced into individual hermetically-sealed chips. Lid wafers made of ceramics are receiving the most attention for this purpose, as ceramic wafers offer the low gas permeability necessary for hermetic sealing, low loss (for RF components), and can be fabricated inexpensively with conductive through-vias for high-density interconnects. With ceramic-to-silicon intermediate-layer wafer-level bonding, the potential for cost reduction relative to die-level packaging is very high. However, this technology has a number of challenges. The most significant of these relates to the coefficient of thermal expansion (CTE) mismatch between the ceramic and the silicon.

To date, ceramics developed for wafer-level MEMS packaging have a CTE roughly twice that of silicon. While at the die level the effect of this moderate CTE mismatch may be small, across a four- or- six-inch-diameter wafer it is a significant problem. The effects of CTE mismatch can be reduced in to ways: (i) develop ceramics with CTEs closer to that of silicon, or (ii) reduce the bonding temperature (currently higher than 280° C.). The first of these is actively being investigated. The second of these can also be applied, but not at the expense of high-temperature stability of the package. If the MEMS package is to undergo subsequent Pb-free solder reflow for board attachment, the MEMS package must maintain solid lid attachment at temperatures up to around 260° C.

### BRIEF DESCRIPTION OF THE DRAWINGS

Embodiments of the invention are described by way of examples with reference to the accompanying drawings, wherein:

FIG. 1 is a side view illustrating pieces having layers of a composition formed thereon that is used to bond the pieces to one another;

FIG. 2 is an In—Sn phase diagram, illustrating the use of an In—Sn eutectic as the composition;

FIG. 3 illustrates a bonding process wherein a component of the composition diffuses out of the composition;

FIG. 4 is a Bi—Sn phase diagram;

FIG. 5 is a Bi—In phase diagram;

FIG. 6 is a Bi—Zn phase diagram;

FIG. 7 shows three side views illustrating a modified bonding process utilizing a solder paste;

FIG. 8 shows three side views illustrating a modified bonding process that is used for sealing a MEMS device; and

FIG. 9 is a block diagram of a computer system in which the structures of FIGS. 1 to 8 may reside.

### DETAILED DESCRIPTION OF THE INVENTION

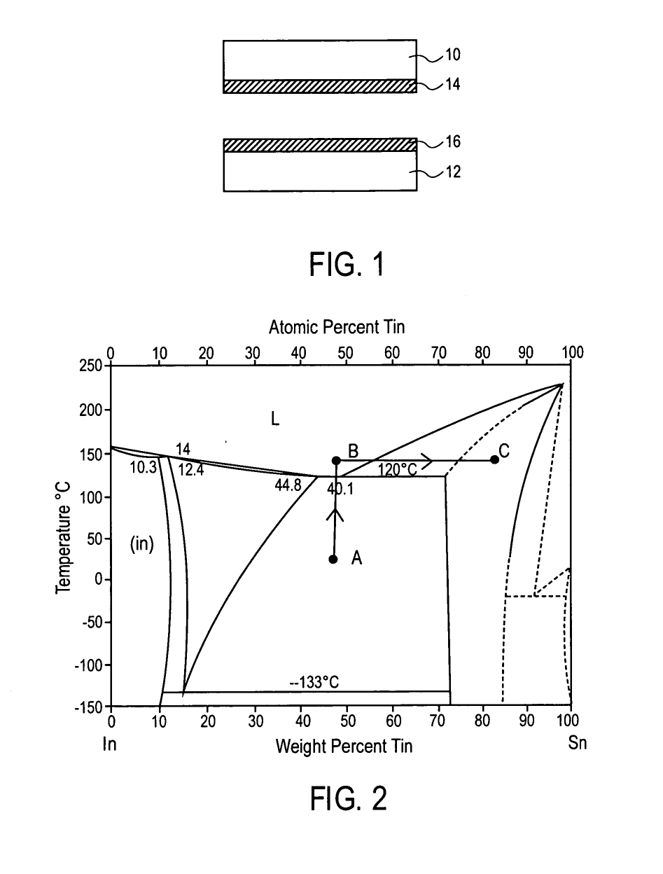

FIG. 1 of the accompanying drawings illustrates first and second pieces 10 and 12, and a layer 14 and 16 respectively on each piece 10 and 12. The first piece 10 may, for example, be a carrier substrate, and the second piece 12 may be a microelectronic die holding a microelectronic circuit. The layers 14 and 16 are made of the same composition, which is a low-melting-temperature (Tm) interlayer alloy (LTI).

FIG. 2 illustrates the composition of the layers 14 and 16 at A. The composition is a eutectic In and Sn, and is initially at room temperature of approximately 25° C. The eutectic includes approximately 49% Sn by weight, and approximately 51% In by weight. The eutectic is subsequently heated to B, which is above its melting temperature of 120° C., but below the melting temperatures of In or Sn of approximately 156° C. and 232° C., respectively. The In thus depresses the melting temperature of the Sn.

The In then diffuses out of the composition, so that the composition changes to C on the phase diagram. The weight percentage of the In reduces, and the weight percentage of the Sn increases. The composition indicated at C is a solid. The composition has thus changed from B to C, from a liquid state to a solid state, without a change in the temperature.

Referring now to FIGS. 1 and 2 in combination, the layers 14 and 16 are placed against one another, and the entire assembly illustrated in FIG. 1 is heated to B in FIG. 2. The assembly is then allowed to bake at the temperature of B, so that the In diffuses from the layers 14 and 16 to the pieces 10 and 12.

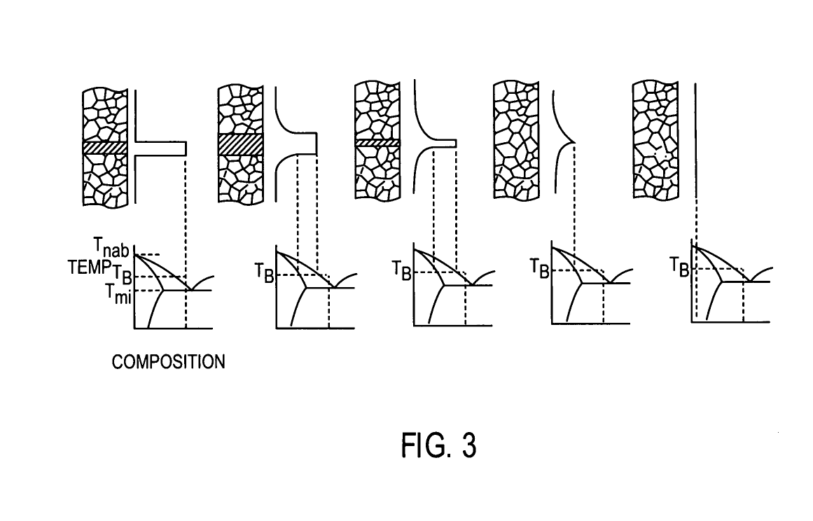

FIG. 3 illustrates how bonding occurs between the pieces 10 and 12 of FIG. 1 utilizing the above process, but using an Si—Bi composition. The process shown in FIG. 3 is a specific version of a process otherwise known as “transient liquid phase (TLP) bonding.” In TLP bonding, a thin interlayer containing a melting point depressant (MPD) is placed between two parent metals to be joined and heated at a bonding temperature, resulting in a thin liquid interlayer. The liquid forms because the melting point of the interlayer is low or because reaction with the parent metals results in a low melting liquid alloy. The liquid then fills microscopic voids, and sometimes dissolves residual surface contamination. With time, the MPD diffuses into the parent metals. As the MPD diffuses away, the interfacial region becomes enriched in the rest element, which solidifies isothermally due to depletion of MPD and therefore increases in melting point. After this bonding process is completed, the resulting joint will have a much higher melting temperature because of a rather uniform distribution of MPD, making this technology ideal for heat-sensitive device applications.

For successful TLP bonding, there are a number of metallurgical restrictions; (i) the interlayer should be a low-melting alloy, one component of which should be soluble in the base metal; (ii) the MPD should diffuse rather rapidly; (iii) the MPD should not be harmful to mechanical properties of the base metal; and (iv) brittle intermetallic compound formation should be minimized at the interface.

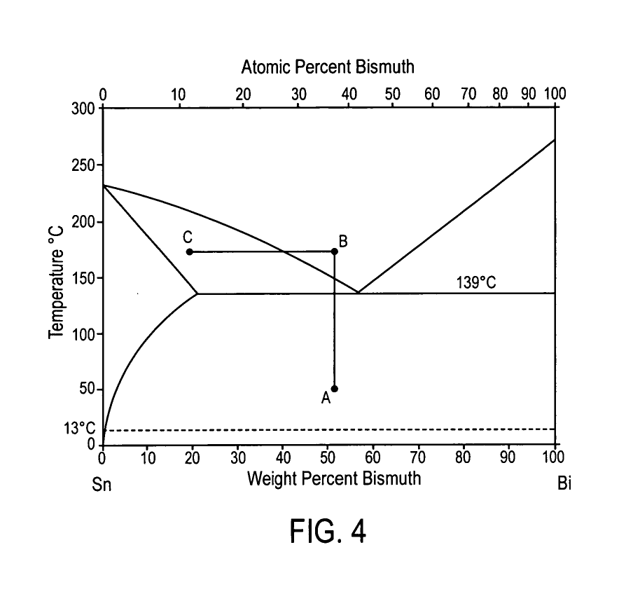

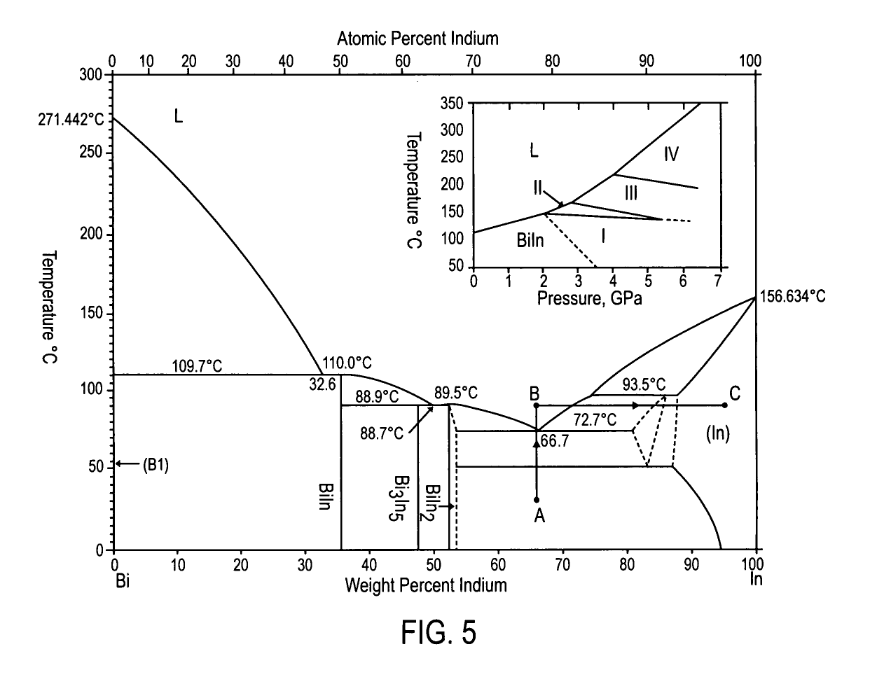

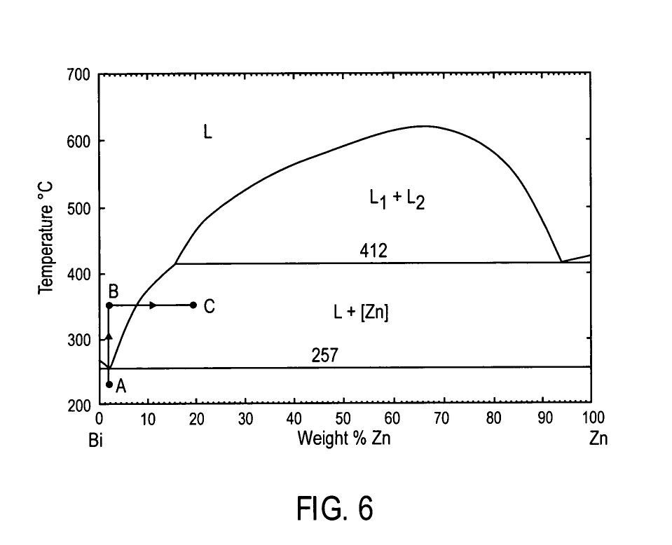

FIGS. 4, 5, and 6 are Sn—Bi, Bi—In, and Bi—Zn binary phase diagrams. Table 1 lists possible starting compositions that may be similarly used, including binary compositions for the phase diagrams of FIGS. 2, 4, 5, and 6, and other three-component and four-component compositions of In, Sn, Zn, and/or Bi.

TABLE 1
Compositions of “Eutectic” Sn—In—Bi—Zn Based LTI Alloys

| Low Tm Interlayer | Eutectic Melting | Example of Bonding Temp. |
|---|---|---|
| (wt. %) | Temp. (C.) | (10 C. above Tm.) (C.) |
| In—48Sn | 118 | 128 |
| Bi—33In | 110 | 120 |
| Bi—33In—0.3Zn | 108 | 118 |
| In—46Sn—1.5Zn | 107 | 118 |
| In—47Bi—0.4Zn | 86 | 96 |
| Bi—25In—19Sn | 79 | 89 |
| In—34Bi | 72 | 82 |
| In—33Bi—0.5Zn | 68 | 78 |
| In—32Bi—20Sn | 59 | 69 |
| In—35Bi—16Zn—0.4Zn | 58 | 68 |

Note that the metals of Table 1 do not include Cd. In addition to the eutectic compositions listed in Table 1, non-eutectic alloys may be used, as listed in Table 2.

TABLE 2
Composition Range of “Non-Eutectic” Sn—In—Bi—Zn Based
Alloys

| Sn (wt. %) | In | Bi | Zn | Liquidus Range (C.) |
|---|---|---|---|---|
| 42-19 | 0-25 | 58-56 | 0 | 138-79 |
| 48-20 | 52-48 | 0-32 | 0 | 118-59 |
| 0-19 | 33-25 | 67-56 | 0 | 110-79 |
| 0-20 | 67-48 | 33-32 | 0 | 72-59 |
| 48-46 | 52-52 | 0 | 0-2 | 118-107 |
| 0 | 33-33 | 67-66 | 0-1 | 110-108 |
| 0 | 33.4-52.2 | 66.3-47.4 | 0.3-0.4 | 108-86 |
| 0 | 52.2-66.8 | 47.4-32.7 | 0.4-0.5 | 86.68 |
| 0 | 66-66.8 | 34-32.7 | 0-0.5 | 72-68 |

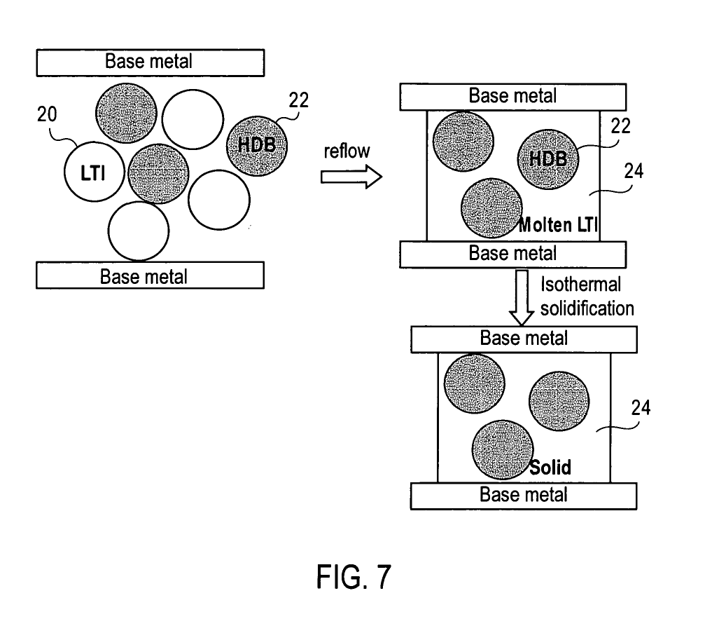

The principles described above can be used in a solder paste as illustrated in FIG. 7. The solder paste consists of an LTI powder 20 which will melt at low temperatures, typically less than 180° C., and a high Tm base alloy (HTB) powder 22, which can dissolve some of the elements in the LTI. During paste reflow, some of the MPD in the LTI will diffuse into the HTB powder 22 and eventually isothermal solidification will happen due to composition changes in the LTI alloy 24 and the HTB powder 22. The HTB powder 22, which serves as an MPD sink, is dispersed together with the LTI alloy 24 so that diffusion time of the MPD is significantly reduced, and therefore faster bonding time can be achieved. After bonding is completed, a resulting joint will have a much higher temperature, and therefore enhanced reliability.

HTB alloys in some embodiments ideally have the following requirements: (i) HTB alloys have higher Tm than LTI alloys, (ii) HTB alloys have solubility of at least one of the MPD in LTI alloys, and (iii) no intermetallic compound formation can occur between constituents of LTI alloys and HTB alloys. Based on the above criteria, any LTI alloy listed in Table 2 can be used as HTB in combination with the LTI that has a lower Tm. For example, In-48Sn can be used as HTB in combination with In-33Bi-0.5Zn to realize a bonding temperature of around 78° C. In addition to this type of combination, the following alloys can be also used as HTB alloys.

TABLE 3
Additional HTB Alloys

| High Tm Alloy | Melting Temperature (C.) |
|---|---|
| Sn—xIn (x = 0 to 52) | 118 to 232 |
| Sn—xBi (x = 0 to 58) | 138 to 232 |
| Sn—xZn (x = 0 to 8.8) | 198 to 232 |

TLP paste can be prepared by mixing LTI and HTB powders along with usual flux and solvents, etc. TLP paste can then be applied to the base metals using conventional processes such as screen or stencil printing. The base metals can be contact metals or contact metal/solder sphere combinations, etc. The whole assembly is heated at a bonding temperature above the melting temperature of the interlayer but below the melting temperature of the contact material for a certain period of time.

During bonding, the interlayer regions will melt and interdiffusion will take place because of the concentration gradient between the contact and interlayer materials (for example, Bi, Zn, and In will be diffusing away from the interlayer to the contact materials, to increase the remelting temperature of resulting joints). The liquid layer will eventually disappear when the MPD diffuses out sufficiently. Alternatively, the entire assembly is cooled down after a certain bonding time.

The presence of HTB powders inside the paste will reduce the diffusion length and therefore the bonding time. Once bonding is complete, the joint will have a much higher remelting temperature depending on the base metals, interlayer composition, and thickness, and the bonding time/temperature with the upper limit approaching the melting temperature of the base metals.

If the base metal or top surface of the base metal is an HTB alloy, a TLP bonding joint will also be formed between the LTI powder and the base metal interface. If the base metal is not an HTB alloy but, for example, a conventional solder (Sn—Ag—Cu, for example), then intermetallic compounds are likely to form at the LTI powder and base metal interfaces. Either case can give rise to a higher remelting temperature, because the MPD will all be consumed by the HTB alloy powder coexistent with the LTI powder.

This joining process using the materials described can be applicable to various bonding, including but not limited to first and second level interconnects (flip-chip bumps or BGA interconnects), MEMS hermetic sealing, thermal interface bonding, etc. The LTP bonding techniques described above can also be used for attaching lids to MEMS, dies, or wafers using low-temperature LTP (LTTLP) bonding techniques. LTTLP bonding produces hermeticallurgical bonds that are stable during subsequent high-temperature assembly processes, and offer high long-term reliability due to a higher remelting temperature.

In addition to the above restrictions, the application of TLP technology to wafer-to-wafer bonding for MEMS in some embodiments requires that: (i) the thicknesses of the metals be chosen such that after diffusion of the MPD, the parent metal still adheres to the wafers and its composition has not changed detrimentally; (ii) the roughness of the interface is sufficiently smaller than the thickness of the MPD (otherwise voiding would occur); (iii) there exists a suitable method to deposit the MPD on a wafer (for example, by screen printing or sputtering); and (iv) the bonding process can be carried out without the use of flux, which would damage the MEMS devices.

The key features of LTTLP bonding are:

1. A low bonding temperature, tunable to specific requirements.

2. After bonding, the resulting structure typically has a much higher remelting temperature. Higher remelting temperatures of the resulting joint mitigates reliability concerns in conventional low-temperature solders, and make subsequent high-temperature assembly processes possible.

3. A metallurgically indistinguishable and interface-free joint (absence or low concentration of brittle intermetallics) without remnants of the bonding agent for superior joint integrity.

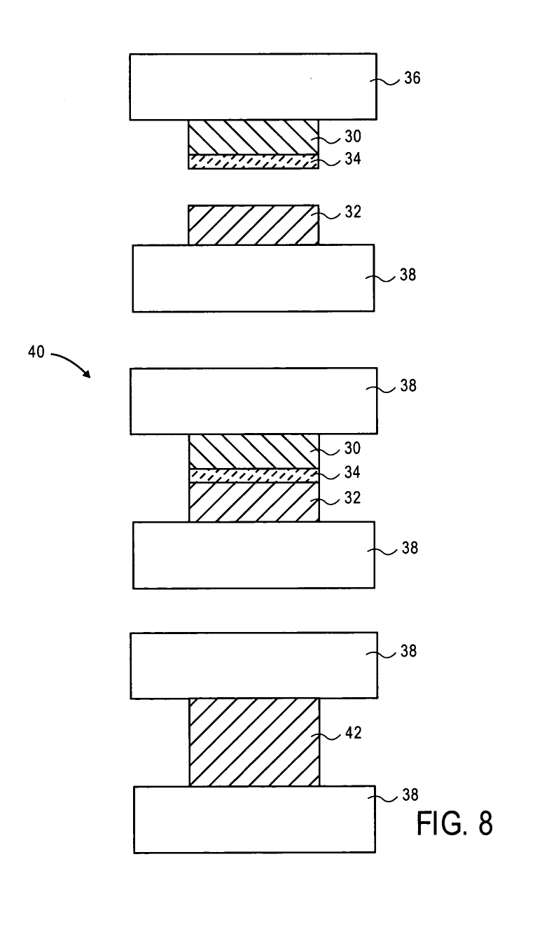

FIG. 8 illustrates how hermetic encapsulation of a MEMS device via a lid attachment can be achieved. First, the bonding material is patterned into seal rings around the active MEMS components.

Deposited Layers. Metals 30 and 32 can be Sn-xIn. The interlayer 34 can be deposited on either the metal 30 of the lid wafer 36 or on the metal 32 of the MEMS wafer 38.

Initial Contact/Bonding. The lid wafer 36 and the MEMS wafer 38 are aligned and brought into contact. A small compressive force is applied between the lid wafer 36 and the MEMS wafer 38 (note that high pressure is not needed for TLP bonding), the stack 40 is heated to a temperature above the melting point of the interlayer 34, and held at that temperature as isothermal solidification is allowed to proceed.

Isothermal Solidification. The stack 40 is baked or annealed for completion of “isothermal” solidification due to interdiffusion of constituents. After bonding, the resulting joint 42 has a much higher melting temperature than that of the interlayer 34.

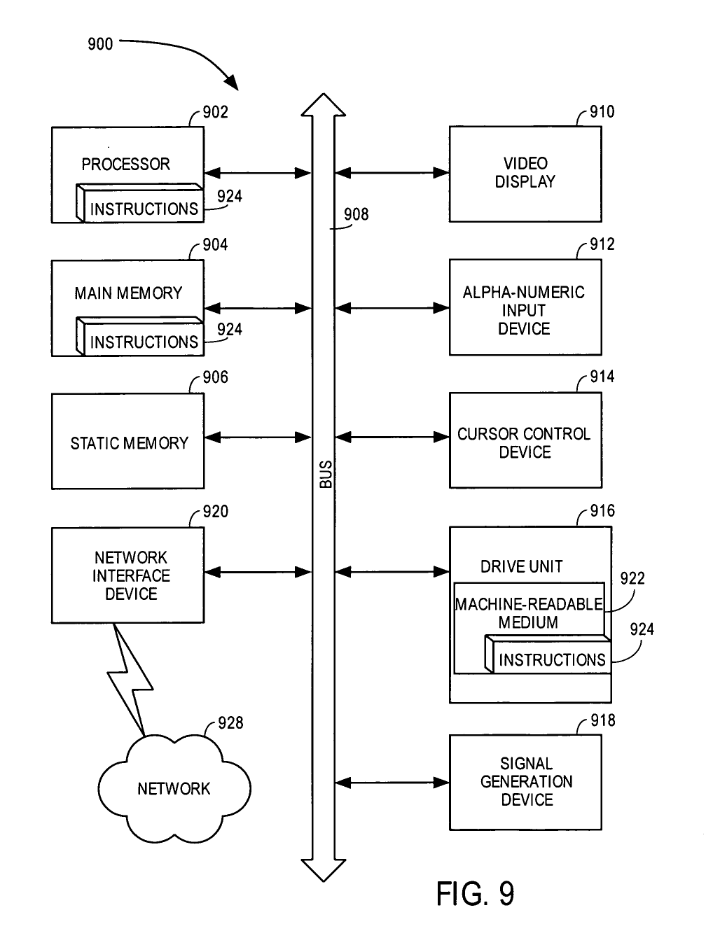

FIG. 9 shows a diagrammatic representation of a machine in the exemplary form of a computer system 900 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processor 902 (e.g., a central processing unit (CPU), a graphics processing unit (GPU) or both), a main memory 904 (e.g., read only memory (ROM), flash memory, dynamic random access memory (DRAM) such as synchronous DRAM (SDRAM) or Rambus DRAM (RDRAM), etc.), and a static memory 906 (e.g., flash memory, static random access memory (SRAM), etc.), which communicate with each other via a bus 908.

The computer system 900 may further include a video display 910 (e.g., a liquid crystal display (LCD) or a cathode ray tube (CRT)). The computer system 900 also includes an alpha-numeric input device 912 (e.g., a keyboard), a cursor control device 914 (e.g., a mouse), a disk drive unit 916, a signal generation device 918 (e.g., a speaker), and a network interface device 920.

The disk drive unit 916 includes a machine-readable medium 922 on which is stored one or more sets of instructions 924 (e.g., software) embodying any one or more of the methodologies or functions described herein. The software may also reside, completely or at least partially, within the main memory 904 and/or within the processor 902 during execution thereof by the computer system 900, the main memory 904 and the processor 902 also constituting machine-readable media.

The software may further be transmitted or received over a network 928 via the network interface device 920.

While the machine-readable medium 924 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A bonding method, comprising:
locating a composition between and in contact with first and second pieces, the composition including a bonding metal which is one of Zn, Sn, In, and Bi, and a melting temperature depressing metal which is different than the bonding metal and is one of Zn, Sn, In, and Bi;
heating the composition to diffuse the melting temperature depressing metal into the first piece and increase the melting temperature of the composition; and
allowing the composition to cool.

2. The bonding method of claim 1, wherein the metals are Zn and Sn.

3. The bonding method of claim 1, wherein the metals are Zn and In.

4. The bonding method of claim 1, wherein the metals are Zn and Bi.

5. The bonding method of claim 1, wherein the metals are Sn and In.

6. The bonding method of claim 1, wherein the metals are Sn and Bi.

7. The bonding method of claim 1, wherein the metals are In and Bi.

8. The bonding method of claim 1, wherein the melting temperature depressing metal diffuses into the second piece.

9. The bonding method of claim 1, wherein the first piece is made of a metal that is the same as the bonding metal.

10. The bonding method of claim 9, wherein the second piece is made of a metal that is the same as the first metal.

11. The bonding method of claim 1, wherein the composition is heated to a temperature below 170° C. to diffuse the metal temperature depressing metal into the first piece.

12. The bonding method of claim 1, wherein the composition involves substantially no Cd.

13. The bonding method of claim 1, wherein the composition does not form an intermetallic compound.

14. The bonding method of claim 1, wherein at least one of the pieces includes a microelectronic circuit.

15. A bonding method, comprising:
locating a composition between and in contact with first and second pieces, the composition being at least one of xZnySn, xZnyIn, xZnyBi, xSnyIn, xSnyBi, and xInyBi, where x and y are weight percentages of the composition;
heating the composition so that it melts; and
baking the composition isothermally so that it solidifies.

16. The bonding method of claim 15, wherein x plus y equals 100.

17. The bonding method of claim 15, wherein x plus y is less than 100.

18. The bonding method of claim 15, wherein the first piece includes a microelectronic circuit.

19. A stack, comprising:
first and second pieces; and
a bonding composition between the pieces, the bonding composition being at least one of xZnySn, xZnyIn, xZnyBi, xSnyIn, xSnyBi, and xInyBi, where x and y are weight percentages of the composition.

20. The stack of claim 19, wherein at least one of the pieces includes a MEMS device.

21. The stack of claim 19, wherein one of the pieces includes an MPD including at least one of zn, Sn, In, and Bi.

22. The stack of claim 19, wherein the first piece is a microelectronic die.
